(19) United States
(12) Patent Application Publication
(10) Pub. No.: US 2026/0208096 A1
(43) Pub. Date: Jul. 23, 2026

(54) Improvements to energy performance in CO2 capture

(71) Applicant: Equinor Low Carbon UK Limited, London (GB)

(72) Inventor: Gervas Franceschini, Derby (GB)

(21) Appl. No.: 19/138,401

(22) PCT Filed: Dec. 11, 2023
(86) PCT No.: PCT/EP2023/085088

§ 371 Date: Jun. 12, 2025

(30) Foreign Application Priority Data
Dec. 13, 2022 (GB) 2218728.0

(51) Int. Cl. B01D 53/14; B01D 53/18

(52) U.S. Cl. CPC B01D 53/1475; B01D 53/1425; B01D 53/18; B01D 2221/16; B01D 2257/504; B01D 2259/65

(57) ABSTRACT

A system for the capture of carbon dioxide (CO2) from a CO2 containing gas stream includes an absorber to contact the CO2 containing gas stream with a sorbent, a desorber to release the CO2 from the sorbent, a lean return stream to return the sorbent from the desorber to the absorber; a main heat exchanger between the desorber and the absorber to remove heat from the lean return stream and add heat to the rich sorbent stream; and at least one additional heat exchanger to add heat to either the lean return stream after the main heat exchanger or to the rich stream before the main heat exchanger so as to produce a hot lean return stream, and a heat pump system configured to remove heat from the hot lean return stream and supply heat to the heating means.

### TECHNICAL FIELD

The present disclosure concerns energy performance of a CO2 capture process.

### BACKGROUND

Carbon capture and storage is expected to be a significant way to reduce the effects of global warming from the combustion of fossil fuels.

Capture of carbon dioxide (CO₂) may involve technology for extracting CO₂ from a CO2 containing gas using an absorbent medium. Typically, this involves creating a gas flow over the absorbent medium under conditions where the medium will absorb CO₂ from the gas, and then altering the conditions so that the medium releases the absorbed CO₂ allowing it to be captured and stored. This process may be used to reduce atmospheric CO2 to mitigate the anthropogenic emissions that are associated with global warming, or climate change. Direct Air Capture (DAC) is the capture of CO2 from atmospheric air which, as the atmosphere contains less than 0.05% CO2, involves processing large volumes of air.

Heat is used to release the absorbed CO2 in temperature swing methods, and it has previously been suggested that in an electrically heated system, a heat pump may be an effective way to supply that heat. EP2512628 A1 for example describes using a heat pump to recover low grade heat energy from various sources. Suggested sources of low grade energy are the condenser and compression systems, and additionally a solvent cooling system provided in a solvent delivery conduit. There remain however, opportunities to increase the heat recovery and improve its efficiency, and to improve the effectiveness of the whole system at the same time.

### SUMMARY OF INVENTION

According to a first aspect there is provided a system for the capture of carbon dioxide (CO2) from a CO2 containing gas stream, the system comprising: an absorber to contact the CO2 containing gas stream with a sorbent, the sorbent operable to capture CO2 from the CO2 containing gas stream in a first temperature range and release CO2 at a second temperature range; the absorber comprising means to move the CO2 containing gas stream through the absorber from an absorber inlet to an absorber outlet; a desorber to release the CO2 from the sorbent, the desorber operable to receive a rich sorbent stream from the absorber, heat the sorbent using heating means to provide heat to increase the sorbent temperature from the first temperature range to the second temperature range, an exhaust conduit to supply an exhaust stream comprising CO2 and vapor to a CO2 outlet; a lean return stream to return the sorbent from the desorber to the absorber; a main heat exchanger between the desorber and the absorber to remove heat from the lean return stream and add heat to the rich sorbent stream; and at least one additional heat exchanger to add heat to either the lean return stream after the main heat exchanger or to the rich stream before the main heat exchanger so as to produce a hot lean return stream; and a heat pump system configured to remove heat from the hot lean return stream and supply heat to the heating means.

In some embodiments the at least one additional heat exchanger is a condenser configured to cool the exhaust stream and produce condensate. The condenser may be configured to have an outlet temperature within a third temperature range, and the condenser is fluidly connected to a condensate recovery circuit to deliver the condensate into the desorber.

The condenser may comprise first and second condensers on the exhaust stream, each configured to cool the exhaust stream and produce condensate, wherein the first condenser receives the exhaust stream before the second condenser during operation.

The heat pump system may be further configured to cool the first condenser and the second condenser may be cooled by the lean return stream or the second condenser is cooled by the rich sorbent stream.

In some embodiments, the second condenser may be cooled by the lean return stream and the first condenser cooled by the lean return stream after it has been heated by the second condenser.

Alternatively, the second condenser may be cooled by the rich sorbent stream and the first condenser cooled by the rich sorbent stream after it has been heated by the second condenser.

In other embodiments, the second condenser may be cooled by the rich sorbent stream and the first condenser cooled by the lean return stream after it has been cooled by the main heat exchanger.

Preferably the CO2 containing gas stream is ambient air.

In another aspect there is provided a method of capture of carbon dioxide (CO2) from a CO2 containing gas stream, the method comprising: providing a condenser system in an exhaust stream from a desorber in a carbon capture system, the condenser operable to recover condensate and deliver it to the desorber; passing either lean or rich sorbent streams of the carbon capture system through the condenser to cool the condenser; recovering heat from the lean return stream using a heat pump to supply heat to heating means in a desorber of the carbon capture system.

The lean sorbent stream may be passed through the condenser to heat the lean sorbent stream, after the lean sorbent stream has been cooled in a main heat exchanger by heating the rich sorbent stream.

Alternatively, the rich sorbent stream may be passed through the condenser to heat the lean sorbent stream, before the lean sorbent stream is cooled in a main heat exchanger by heating the rich sorbent stream

### BRIEF DESCRIPTION OF DRAWINGS

Embodiments will now be described by way of example only, with reference to the Figures, in which:

FIG. 1 is a schematic of a prior art carbon capture system;

FIG. 2 is a schematic of a carbon capture system with heat pump heat recovery from the absorber,

FIG. 3 is a schematic of a carbon capture system with heat pump heat recovery from the absorber recirculation loop, and the desorber condenser,

FIG. 4 is a schematic of a carbon capture system with heat pump heat recovery from the absorber, with an additional air source heat exchanger,

FIG. 5 is a schematic of a carbon capture system with heat pump heat recovery from the absorber, and heat transfer between the absorber inlet and the outlet,

FIGS. 6 and 7 are charts of sorbent performance at different temperatures,

FIG. 8 is a schematic of a carbon capture system with heat pump heat recovery from the lean return, in a cascade system with heat pump recovering heat from the desorber condenser,

FIG. 9 is a schematic of a carbon capture system with heat pump heat recovery from a hot lean return, in a cascade system with heat pump recovering heat from the desorber condenser,

FIGS. 10-15 show variants and alternative arrangements of the system of FIG. 9,

FIG. 16. is a chart of the energy use of examples of the system at different condenser temperatures,

FIG. 17. is a series of charts of the energy use of examples of the system optimised for heat pump performance,

FIG. 18. is a chart of the energy use of one examples of the system optimised for heat pump performance at different ambient temperatures.

### DETAILED DESCRIPTION

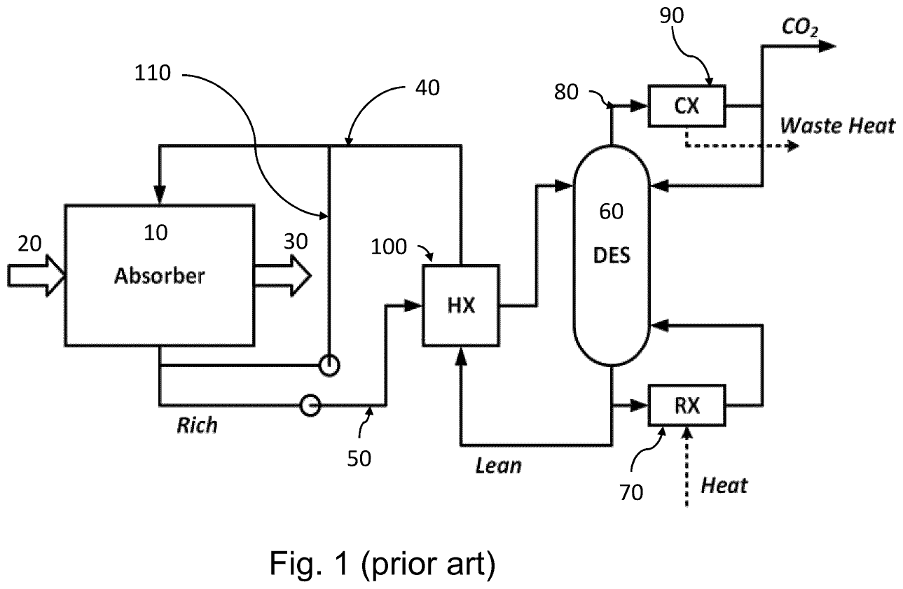

With reference to FIG. 1, which shows a conventional system for carbon capture from a CO2 containing gas. Absorber 10 receives a CO2 containing gas stream from the inlet 20 to outlet 30. A sorbent stream flows through the absorber, a lean stream 40 enters the absorber, contacts the CO2 containing gas and becomes a rich stream 50. Sorbent may be recirculated within the absorber as a recirculation stream 110, which increases the effective residence time of each portion of the lean stream of sorbent in the absorber.

The rich stream is typically passed through heat exchanger 100 to recover some heat from the lean stream returning from the desorber 60. Desorber 60 receives the rich stream and heats it up to a temperature where the CO2 will be released form the sorbent, typically using heating means 70 which may also generate steam to form vapour bubbles into which the desorbed CO2 can diffuse, leaving a lean stream of sorbent to return to the absorber to repeat the process. The vapour and desorbed CO2 exit the desorber at 80, where a condenser 90 is usually used to cool the mixture causing the vapour to condense leaving a purer CO2 product stream.

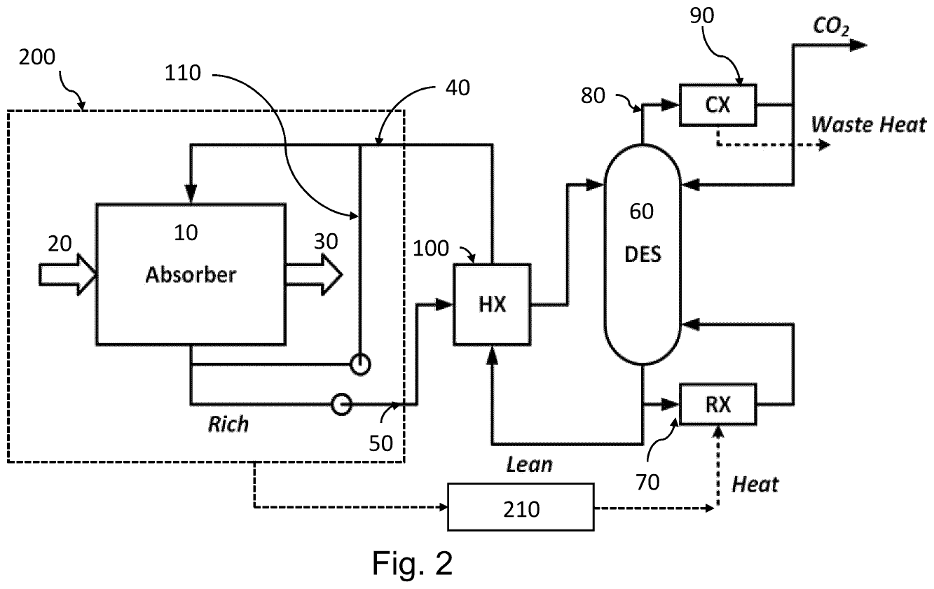

Moving on to FIG. 2, the same reference numbers are used for the same or similar features except where mentioned. Absorber 10 receives a CO2 containing gas stream from the inlet 20 to outlet 30. A sorbent stream flows through the absorber, a lean stream 40 enters the absorber, contacts the CO2 containing gas and becomes a rich stream 50. Sorbent may be recirculated within the absorber as a recirculation stream 110, which increases the effective residence time of each portion of sorbent in the absorber.

The rich stream is optionally passed through main heat exchanger 100 to recover some heat from the lean stream returning from the desorber 60. As this disclosure provides a number of embodiments describing means of heat transfer, this heat exchanger is optionally included or not or may be positioned at different places in the circuit. Desorber 60 receives the rich stream and heats it up to a temperature where the CO2 will be released from the sorbent, using heating means 70. The vapour and desorbed CO2 exit the desorber at 80, where a condenser 90 is usually used to cool the mixture causing the vapour to condense leaving a purer CO2 product stream.

The boundary of the absorber system is marked as a dotted line 200. The absorber system includes the recirculation stream 110 and the inlet 20 and outlet 30. Heat is recovered from the absorber system by heat pump system 210 and delivered to the heating means 70.

The heat pump system has a controller that controls the temperature within the absorber system, so that the sorbent is kept within a preferred range of temperatures while in contact with the CO₂ containing gas. As described below, for any sorbent there is a temperature at which the rate of CO2 absorption is maximised for any given system.

An additional advantage of cooling the absorber is that evaporation is reduced, helping to maintain the fluid balance of the system and reducing water loss which is a significant environmental cost of a liquid based DAC plant. In some atmospheric conditions, it is possible to operate the absorber at a temperature lower than the dew point of the ambient air, so that the vapor pressure of the ambient air exceeds the vapor pressure of air at the absorber temperature. In these conditions, the absorber may gain water from the ambient air, which will assist in making up water loss through drift or from the steam loss in the exhaust of the desorber. The heat pump system controller may control the temperature of the absorber based upon the ambient humidity so as to maintain the liquid balance within the system. The controller may calculate the balance between energy use, CO2 absorption rate and water loss rate and adjust the temperature to achieve the optimum operating conditions based upon price or environmental cost applied to each of these parameters. The controller may receive an environmental cost indicator for CO2 capture, energy use and water loss, and adjust the temperature of the absorber to minimise the overall environmental cost, taking into account the ambient environmental conditions such as humidity and temperature, the environmental cost of energy based upon the current source of energy, and the same for local water resources. The controller may estimate the evaporation rate using a known formula such as the Penman equation or a variation of it.

Heat may be recovered from the absorber system from either the gas stream or the sorbent stream or both, allowing the mean temperature of the sorbent within the absorber to be maintained within a first temperature range at which the rate of CO2 absorption is maximised.

The gas stream and the sorbent stream are in contact within the absorber for at least the residence time of the absorber, and to maximise the transfer of CO2 from the gas stream to the sorbent stream the surface area of contact is preferably large. This may be achieved by the sorbent being delivered as a thin film coating onto packing within the absorber, or by small droplets such as a fine mist. As a consequence of the contact, as well as gas transfer into the liquid, the two stream will rapidly reach thermal equilibrium with one another, and so control of the heat transfer only requires measurement of one stream temperature.

An offset to the desired temperature range may be made based on the difference in either the inlet temperatures or the outlet temperatures of the streams. This may be calculated by sensors measuring the temperature of each stream when in operation. Alternatively, the offset can be calculated by measurement or modelling for a single absorber, and then applying the calculated offset to multiple similar units.

In some cases, there may be multiple absorber units, supplied with common lean and rich streams from a central desorber unit, and having a common recirculation stream for all the absorbers or groups of absorbers. The temperature of the multiple absorbers may be controlled by cooling the recirculation stream, thus supplying cooled or heated absorbent solution to all the absorbers.

On other cases, multiple absorbers may be supplied with gas or air via a common plenum, and the temperature of the absorbers maybe controlled by cooling or heating the supplied gas or air in the plenum.

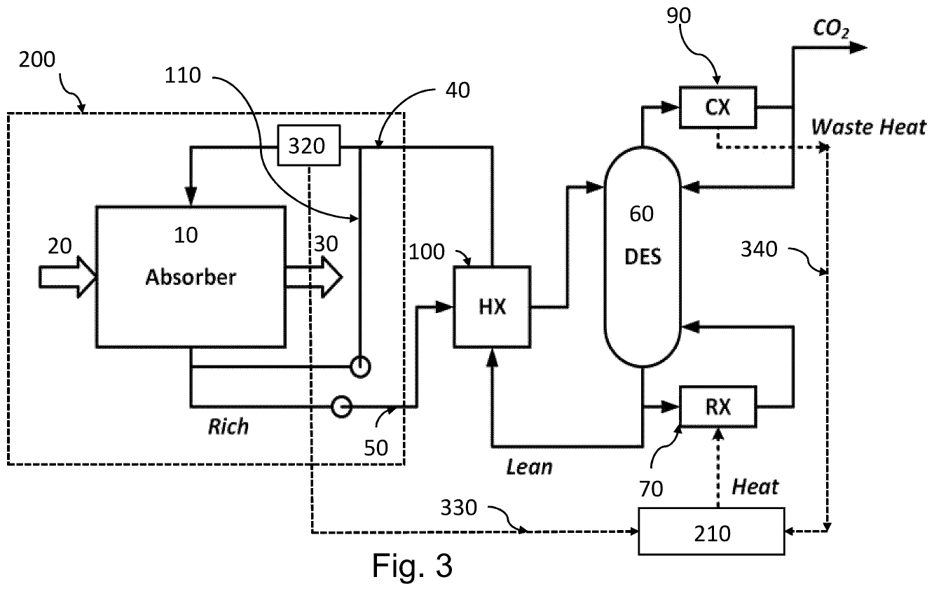

In FIG. 3, features 10 to 210 are similar to those on FIG. 2. Heat is recovered from the absorber system 200 by heat pump system 210 and delivered to the heating means 70.

In FIG. 3, a heat exchanger 320 is shown on the sorbent feed to the absorber, where it is in thermal contact with both the lean return stream 40 from the desorber and the recirculation stream 110. The two streams are mixed in this example before being delivered to the absorber. In other examples, there may be a heat exchanger on one or both of the mixed return stream 40 or recirculation stream 110.

The heat recovery stream 330 transfers heat from the heat exchanger 320 to the heat pump system 210. This may be a refrigerant loop, or it may be another heat transfer fluid that provides thermal transfer between the heat exchanger and the heat pump system.

There may be multiple absorber systems connected to a single desorber. The multiple absorber systems may share a single recirculation stream, and heat recovery can be carried out by a single heat pump system for all the connected absorbers by the use of a heat exchanger.

In the embodiments described above, there is likely in some climatic conditions to be a need for additional heat input to the desorber to supplement the heat recovered from the absorber. This additional heat may be supplied from an external source, for example steam, waste heat from another process, electric heating or any other conventional heat source.

On FIG. 3 there is also shown a high temperature heat recovery path 340 from the condenser heat exchanger 90, which provides additional heat to the heat pump system.

The vapour and desorbed CO2 that exit the desorber will be at a much higher temperature than the absorber. For example, the desorber may operate at 90 to 120 degrees Celsius, while the absorber may operate at 0 to 30 degrees Celsius in ambient conditions, or be controlled at a fixed temperature range to improve sorbent performance as described above. To combine the heat recovery from both units, it may be preferable to have a cascade heat pump system.

The cascade heat pump system may comprise a first heat pump configured to receive heat from the high temperature heat recovery circuit and a second heat pump configured to remove heat from the absorber and deliver heat to the high temperature heat recovery circuit. The coefficient of performance (COP) of each heat pump will be determined in part from the difference in temperature between the high temperature circuit, the absorber and the heating means 70. Therefore by careful design of the system as described herein, the COPs can be optimised in conjunction with maximising the available heat.

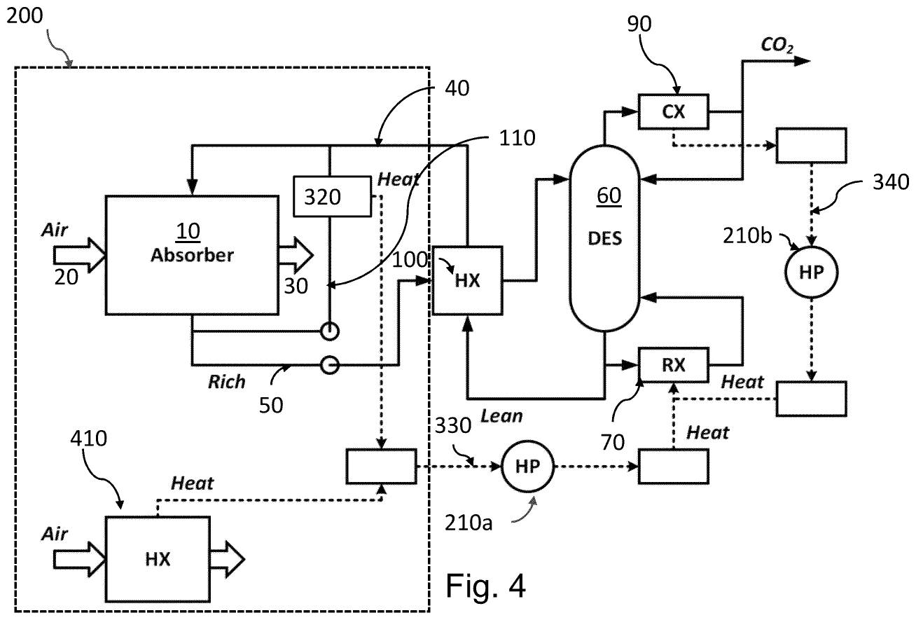

In FIG. 4, features 10 to 210 are similar to those on FIGS. 2 and 3 except that heat pump system 210 is shown as two heat pumps, 210a and 210b. Heat is recovered from the absorber system 200 by heat pump 210a and delivered to the heating means 70. Heat is recovered from the condenser 90 by heat pump 210b. The two heat pumps are shown connected independently, but they could also be arranged as a cascade system as described above. Depending on the choice of heat pumps and refrigerant therein, the overall effective COP of the heat pump system based on the heat delivered by both heat pumps and the energy input might be maximised by having heat pump 210a operate between the absorber temperature and the heating means temperature, or between the absorber temperature. This result will also depend on the choice of condenser heat exchanger off temperature. This enables the overall heat recovery to be maximised with the minimum amount of mechanical energy input to the heat pumps, which may be electrically powered.

There is also shown an air heat exchanger 410 which is also connected in a heat transfer relationship with heat pump 210a. This heat transfer relationship is reversible, for example in a variable refrigerant flow system or other ways known to the skilled person. This enables the balance of heat supply to the heating means 70 to be maintained in hot or cold climatic conditions while maintaining the absorber temperature within the first operating temperature range at which the rate of CO2 absorption is maximised.

In summer conditions, the absorber will be absorbing heat from the ambient air that passes through it, while the recirculating loop 110 is cooled to remove this heat and keep the absorber within first temperature range. If the heat recovered from the recirculating loop exceeds the heat required by heating means 70, then excess heat may be dumped through air heat exchanger 410. In winter conditions, it may be necessary to add heat to the absorber to maintain a minimum temperature within the first temperature range, and also to prevent freezing. This additional heat can be obtained by operating the air heat exchanger in the manner of an air source heat pump. The air heat exchanger 410 may have its own fan to move air through it, or it may be connected via a plenum to the same air movement means used by the absorber.

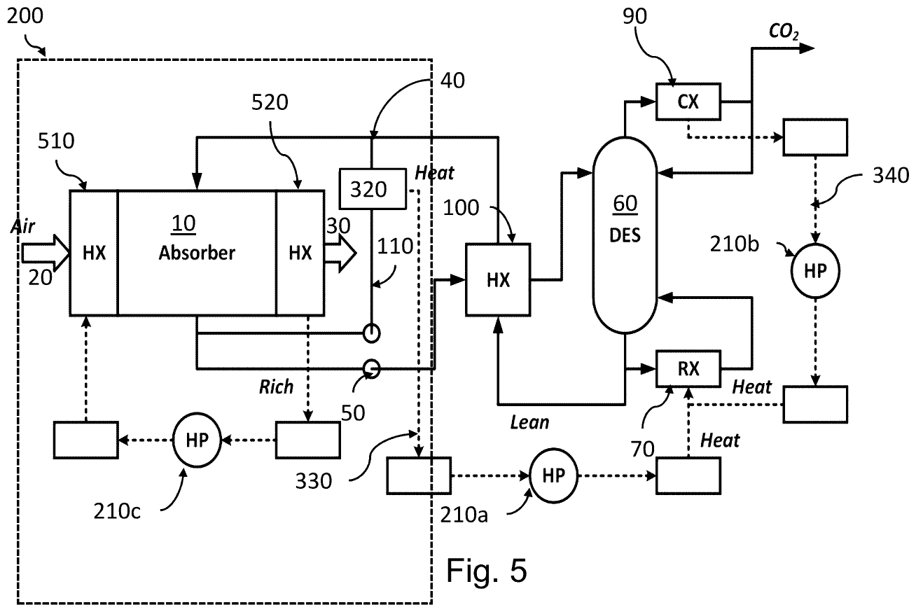

In FIG. 5, air heat exchangers 510 and 520 are affixed to the inlet 20 and outlet 30 of the absorber 10, so that they exchange heat with the air entering and leaving the desorber. Air heat exchangers 510 and 520 are connected to reversible heat pump 210c. This arrangement means that the inlet air can be either heated or cooled by transferring heat between the inlet and outlet using the heat pump 210c.

Heat pump 210c controls the temperature within the absorber system, so that the sorbent is kept within a preferred range of temperatures while in contact with the CO2 containing gas. Heat pump 210a may continue to extract heat from the recirculation loop 110 to supply heat to the heating means 70.

When operating in cold climatic conditions, heat pump 210c will be cooling the exhaust air 30 to below the ambient temperature, while warming the inlet air to above the preferred temperature sufficiently to allow the cooling of the recirculation loop to balance the temperature within the absorber at the desired temperature. There may be a need for a defrost cycle for heat pump 210c if the outlet heat exchanger 520 begins to accumulate ice, this process is similar to that used in conventional air source heat pumps.

When operating in hot climatic conditions, heat pump 210c will be warming the exhaust air 30 to above the ambient temperature, while cooling the inlet air to sufficiently above the preferred temperature to allow the cooling of the recirculation loop to balance the temperature within the absorber at the desired temperature. There may be a need for a defrost cycle for heat pump 210c if the inlet heat exchanger 510 begins to accumulate ice.

Because the air heat exchangers 510 and 520 are able to extract additional heat from the ambient air, this combination can supply additional heat demand required by the desorber. When the ambient temperature is already within the desired range, heat pump 210c may be idle.

When there are multiple absorber units, they may all be connected to common inlet and outlet plenums, and the air heat exchangers may be placed in the common plenums, simplifying the provision of heat pump 210c.

### Sorbent Properties:

Sorbents for carbon capture generally have a changing equilibrium between the carbonate form and being in solution with CO₂ that depends on temperature. Sorbents are carried in a solvent, for example water, which may contain further additives that can act as catalysts, modify the solution physical properties, reduce degradation or other desirable properties.

For each sorbent in solution, an optimum temperature range in which the rate of absorbing carbon dioxide from the surrounding gas in the absorber is high can be determined. Given the large number of variables, experimental measurement of the optimum temperature range for a particular sorbent solution under particular absorbing conditions may be needed.

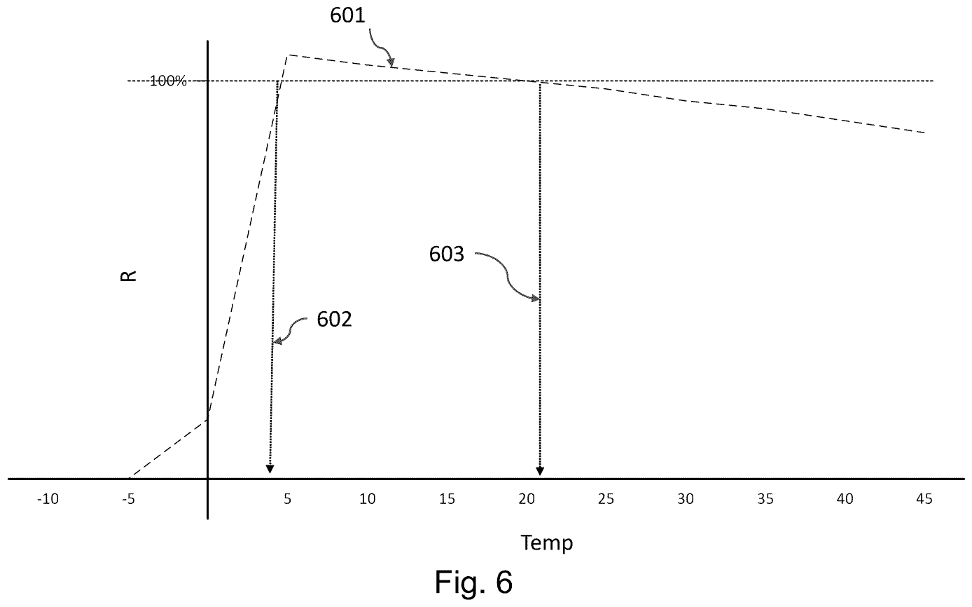

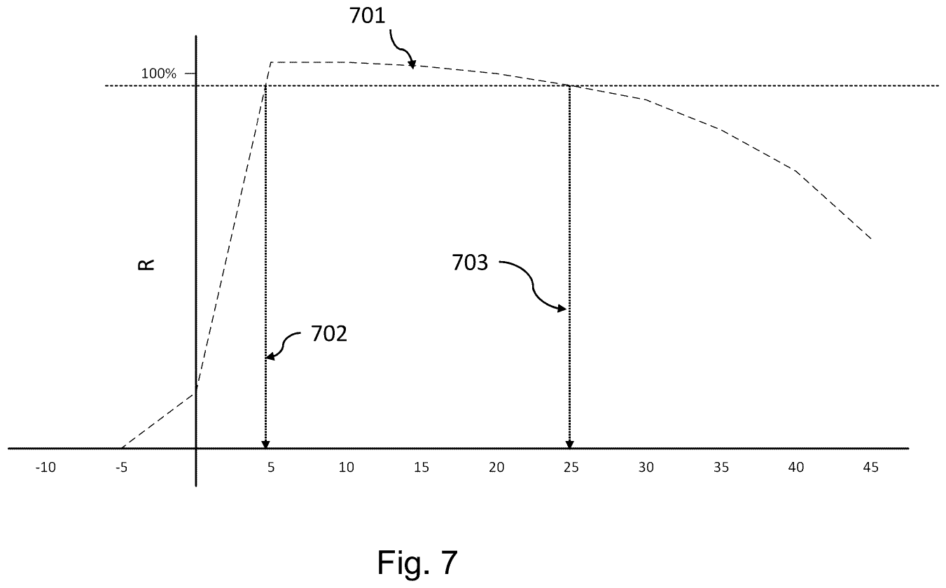

FIG. 6 and FIG. 7 each show an example plot (601,701) of the temperature performance of a sorbent solution against temperature in ° Celcius. The temperature performance “R” is the overall rate of CO2 absorption which could be for example in Kg Co2 per hour for a given absorber and sorbent combination, expressed as a percentage of the rate achieved at a standard condition, in this case 20° Celcius. On FIG. 6 lines 602 and 603 are the lower and upper bounds of the desired operating temperature range to achieve at least 100% of the standard rate, which in the example is around 4 to 21° C. On FIG. 7 702 and 703 are similar points, but aimed at achieving around 95% of the standard performance between 4 and 25° C. The two charts are illustrative data for two different sorbent solutions, for example MEA or an amino acid salt. The data in the charts should not be taken to be accurate, the charts are provided as an example of how the operating range may be determined once the performance of a sorbent solution has been characterised.

The temperature range can be expressed as the minimum and maximum temperature of the contacting area of the absorber, i.e. the temperature of the sorbent inside the absorber while it is in contact with the CO2 containing gas. In general, where the absorber is an air to liquid contactor in a DAC system, the temperature of the sorbent and the temperature of the air within the absorber will be very close, as the sorbent is distributed in a thin film or droplets to achieve a high surface area and contact time, and the air flow is relatively high.

The rate of absorbing CO2 from the surrounding gas can be defined by the change in the number of carbonated sorbent molecules per unit time, or per pass through the absorber. For an absorber with a fixed rate of gas and liquid flow, and difference in CO2 saturation between rich and lean streams, the rate can be expressed as the rate of CO2 removal from the gas stream per unit time.

In this application, except where otherwise stated, the rate of absorbing CO2 will be expressed as a percentage of the rate of absorbing CO2 at 20° C. Thus where sorbents perform better at other temperatures, the rate may exceed 100%. Expressed in this way, the rate can be understood whether it is applied at laboratory scale, or in a large scale carbon capture plant, even though the actual rate may vary greatly when other parameters are changed.

The optimum temperature range for a sorbent, is therefore expressed as the minimum and maximum temperatures between which the rate of absorbing CO2 exceeds a threshold, for example where the rate is greater than 95%.

In a complete model of operating a CO2 capture system system, other factors than absorbing efficiency may need to be taken into account, such as energy efficiency, sorbent degradation rate, loss of sorbent, maintenance costs etc. For any CO2 capture system the threshold for rate of absorbing may be set taking into account all the other factors, to give the best overall operation of the system.

For some sorbent chemistries, the optimum range is narrow and it is desirable to operate a heat management function closely to keep within the desired range. For other sorbent chemistries, the optimum range is fairly broad and a heat management function is only really needed on very cold and very hot days.

Sorbents may include alkaline absorbents such as hydroxides or organic sorbents. Alkaline sorbents may include potassium hydroxide or calcium hydroxide. Organic sorbents may include amines, amino acids. Amines may include Ethanolamine (2-aminoethanol, monoethanolamine, ETA, or MEA).

Preferred sorbents include amino acids or alkali salt solutions of amino acids. The amino acids may be derived from the group consisting of alanine, arginine, asparagine, aspartic acid, cysteine, glutamic acid, glutamine, glycine, histidine, isoleucine, leucine, lysine, methionine, ornithine, phenylalanine, proline, sarcosine, selenocysteine, serine, taurine, threonine, tryptophan, tyrosine, or valine. The amino acid may be a compound of an amino acid, such as a methyl amine or diethyl amine.

Preferred alkali component of the amino acid salts is potassium or sodium. Examples of amino acid salts include, sodium glycinate, potassium lysinate.

Amino acids are preferred because they are understood to have lower heat requirements for desorption, have less degradation than amines, and are less hazardous in use than many of the alternatives. They do however generally have a smaller range of temperatures for absorption to achieve a desired CO2 absorption rate. The invention described herein is particularly advantageous when applied to a CO2 capture system using amino acids and their salts and compounds, as the carbon capture performance is enhanced by keeping the absorbing medium within the optimum temperature range.

By combining heat recovery using a heat pump with control of the absorber temperature, there is a double benefit to the carbon capture system which together increase the amount of CO2 captured per unit of energy consumed. Each mole of sorbent absorbs more CO2 per pass through the absorber while the energy used to desorb the CO2 form the sorbent is reduced by the heat pump.

When combined with other heat recovery options described herein, the entire heat requirements of the desorber can be provided using only electrical or mechanical energy input to the heat pumps, requiring less primary energy than would otherwise be the case.

### Hot Side Arrangements

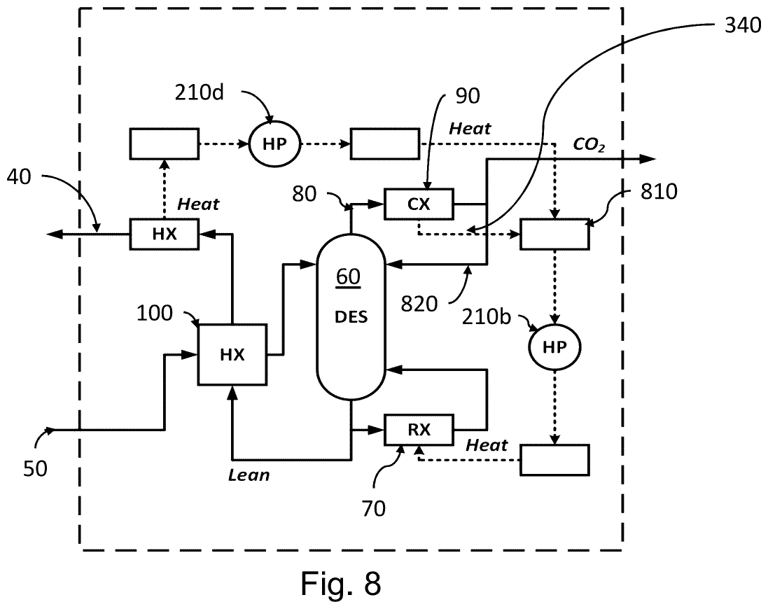

Turning now to FIG. 8, only the hot side of the system is shown. The absorber and associated heat recovery options may be any of the arrangements shown in FIGS. 1 to 5, connected to the lean line 40 and rich line 50.

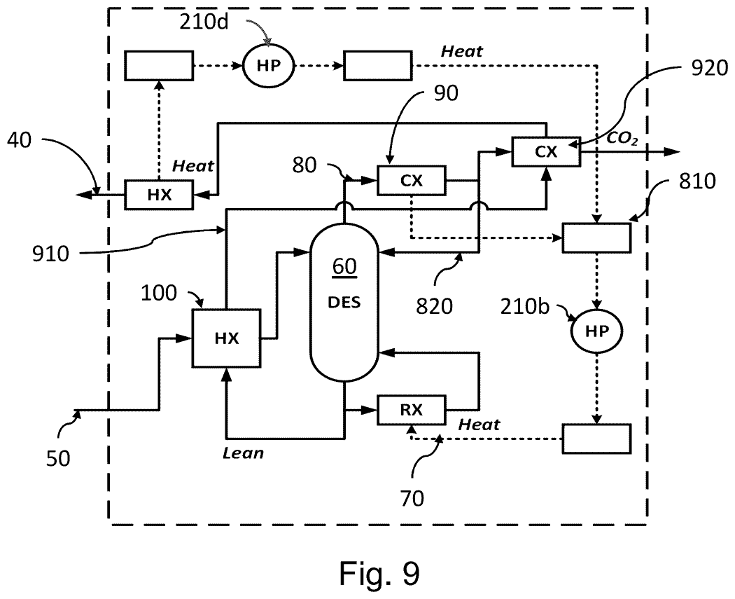

The heat pump system in FIG. 9 includes heat pump 210b recovering heat from the condenser 90, and heat pump 210d recovering heat from the lean line 40. Heat pump 210d recovers heat from the lean return at an intermediate temperature between that of main heat exchanger 100 and the absorber, and cools the lean return down before it is returned to the absorber, the heat is supplied then to an intermediate circuit 810 where it is combined with heat from the condenser. Heat pump 210b can operate at a high coefficient of performance because the temperature difference between the condenser and the heating means 70 is small. The heating means may require heat at 120-130° C., while the condenser can be sized to cool the exhaust stream 80 to for example just below the dew point of the exhaust mixture, recovering most of the latent heat from the exhaust. The condensate line 820 returns hot condensate, which is mostly water, back to the desorber 60. By keeping the condensate temperature high, the sensible heat required to reheat the condensate to the desorber temperature is small, while the COP of the heat pump is high, reducing the overall heat requirement of the system. Additional moisture present in the exhaust stream after the condenser may be removed later at a lower temperature, or even during a compression cycle if the CO2 is compressed for further processing. This additional condensate can be injected back into the system elsewhere to help maintain the water balance. Because heat pump 210d only raises the temperature of the heat from the lean return temperature to the condenser temperature, rather than all the way to the temperature required for the heating means, a greater choice of heat pumps are available, as heat pumps that can supply heat at above 100° C. tend to be complex and require specialist refrigerants. This means that we can run a high coefficient of performance dedicated heat pump between the condenser temperature and the reboiler for the full amount of heat required and feed the intermediate temperature reservoir 810 with heat either from the condenser or from other sources (including from other lower temperature heat pumps) such that the heat extracted from the intermediate reservoir matches the heat supplied to the intermediate reservoir. Optionally, external heat may be added from the absorber side. It may be from a separate air source heat pump, ground source heat pump, water source heat pump, from an external industrial process or waste heat from locality. It may be from a combination of sources.

FIG. 9 shows another option for the hot side heat recovery. All the features of FIG. 8 are present as described above. In addition, a second condenser 920 is shown which recovers latent and sensible heat from the exhaust gas 80 after it has passed through the first heat exchanger of condenser 90. The lean return line 910 has been cooled by the rich line 50 in the main heat exchanger, and is then passed through the second condenser 920 where it recovers some of the remaining enthalpy of the exhaust. This additional heat is then recovered by heat pump 210d, which now has an improved COP and more available heat to recover due to the higher temperature of the lean return 910.

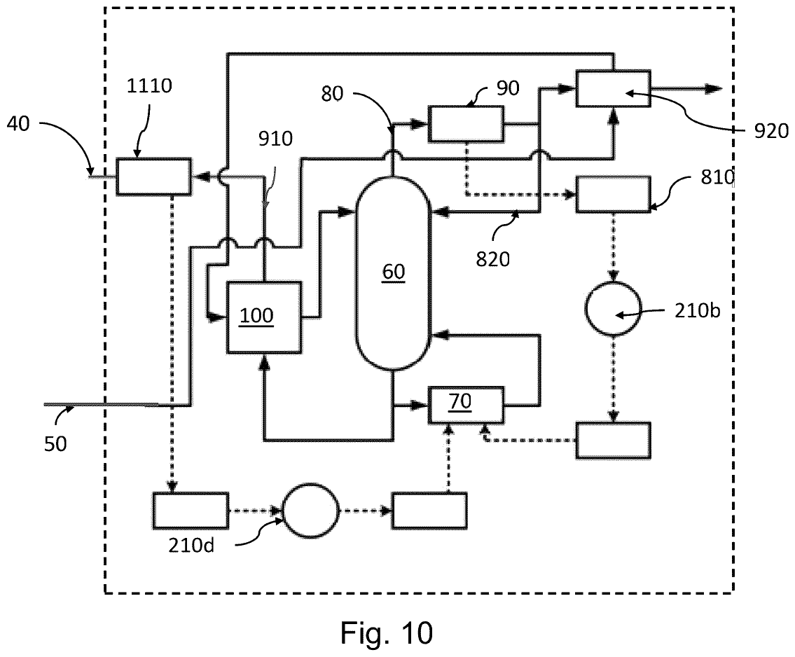

FIG. 10 shows similar features to FIG. 9, hot condensate 820 may be recovered after the first condenser heat exchanger 90. The second condenser is cooled by the cool rich line 50 returning from the absorber at the absorber temperature, which may be close to ambient temperature, and is preheated in condenser 920 before it receives further heat in the main heat exchanger 100 from the lean line that is at a temperature close to the desorber temperature. In this example, the main heat exchanger may be smaller or remove less heat from the lean line 910 than would normally be used which means the lean line has greater heat available, i.e. it is hotter, for recovery by heat exchanger 1110 and heat pump system 210d. The result of lean return 910 exiting main heat exchanger 100 at a higher temperature, is an improvement to the COP of heat pump 210d and making more heat available for recovery. Because the rich line 50 will be close to ambient temperature, or even below ambient temperature if the features of FIGS. 2 to 5 are combined with those shown, the heat recovered from the second condenser 920 provides a preheat to the rich line with little additional energy requirement. The resulting exhaust of CO2 is also drier, which reduces the post-processing required before storage or further use. Heat pump 210d may deliver heat directly to heating means 70 as shown, or alternatively it may deliver heat to the input of heat pump 210 d to form a cascade heat pump system as described elsewhere for example in FIG. 8.

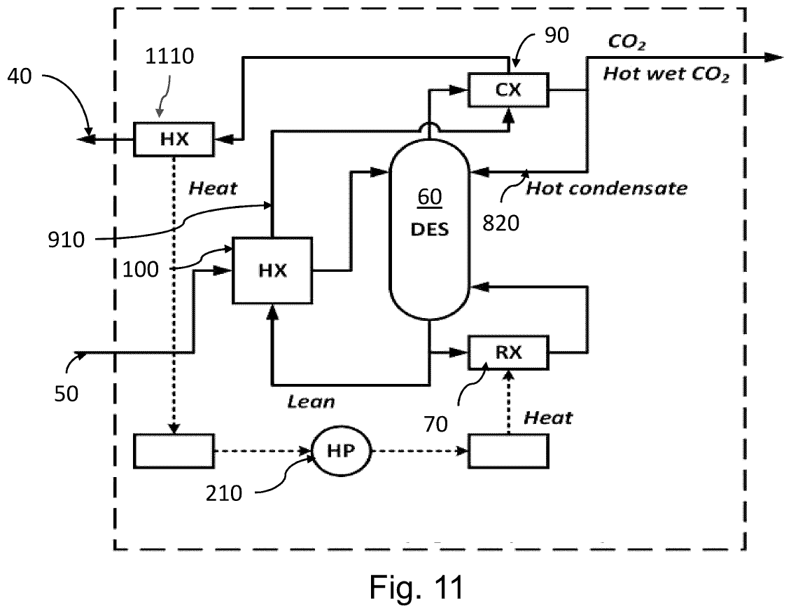

FIG. 11 now shows a system where the lean line 910 is reheated by the condenser 90 after exchanging heat with the rich line 50 in the main heat exchanger 100. In this example, heat pump system 210 recovers heat from the heat exchanger 1110 on the lean line 40 after the condenser, thus recovering heat from both the condenser and the lean line return using only a single additional heat exchanger and heat pump. By making the lean return hot, the enthalpy of the condenser is captured and the single heat pump will have a high coefficient of performance, while also capturing any residual heat in the lean line before it is is lost in the absorber.

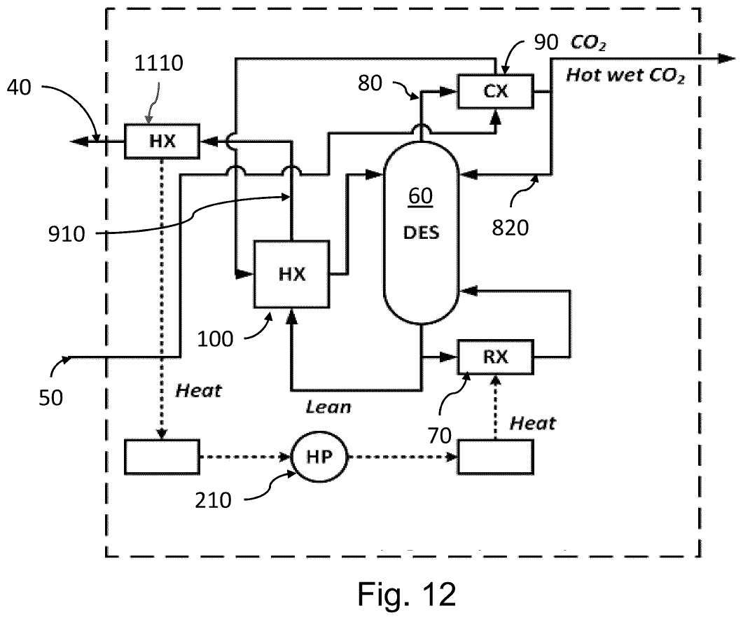

FIG. 12 is a variant of the system shown in FIG. 11, but in this case the rich line returning from the absorber at the absorber temperature, which may be close to ambient temperature, is preheated in condenser 90 before it receives further heat in the main heat exchanger 100 from the lean line. In this example, the main heat exchanger may be smaller or remove less heat from the lean line 910, which means the lean line has greater heat available for recovery by heat exchanger 1110 and heat pump system 210.

In both FIGS. 11 and 12, additional heat may be recovered from the absorber or other low temperature sources to provide additional heat to heating means 70, using additional heat pumps either directly feeding the heating means or in a cascade arrangement with the heat recovery from the hot lean line.

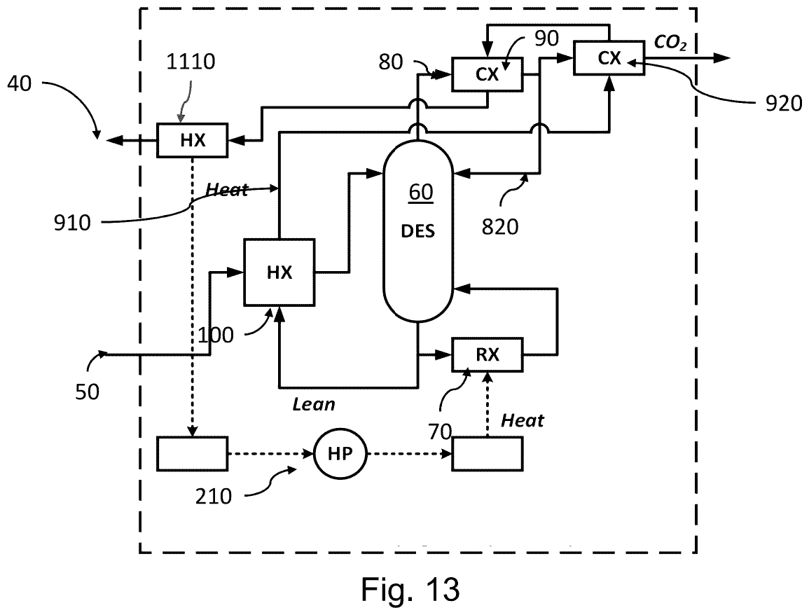

In FIG. 13, another variant of the hot lean line system of FIGS. 11 and 12 is shown. As in FIG. 9, a second condenser 920 is used to further cool the exhaust from the desorber 80, allowing the first condenser 90 to be sized optimally to maximise the latent heat recovery from the exhaust stream and return hot condensate 820 to the desorber. The second condenser here is cooled by the cool lean line 910, which then passes into the first condenser 90. The now hot lean line passes through heat exchanger 1110 where heat is collected by heat pump system 210 to supply heating means 70. The advantage of this arrangement is that the temperature of the condensate 820 can be set by sizing of the two condensers, returning hot condensate to the desorber and returning the cooler condensate from the second heat exchanger elsewhere in the system to make up the balance of liquid. At the same time, only a single heat pump needs to be used to manage the condensate and the lean line heat recovery.

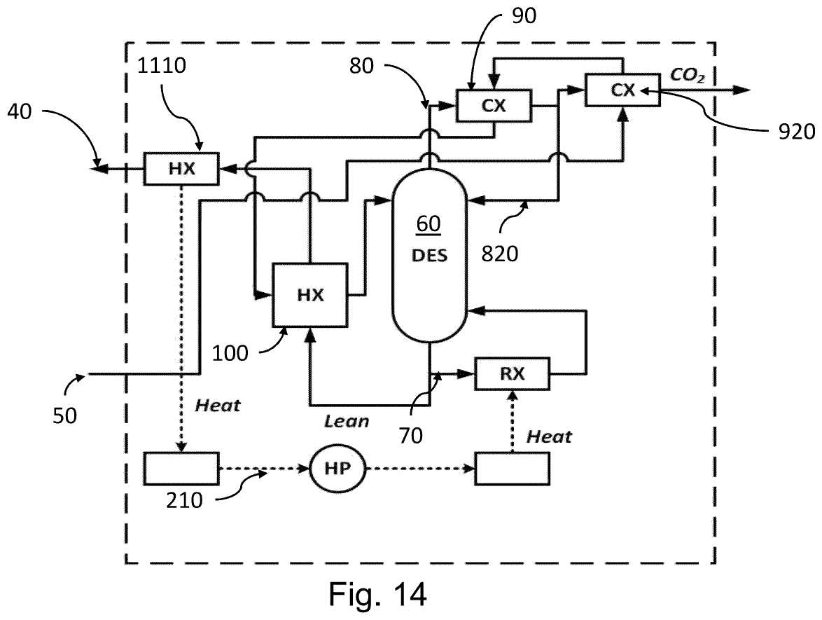

FIG. 14 is a similar arrangement to FIG. 13, except that the cool rich return 50 is used to cool both condensers. As in FIG. 12, the rich line 50 returning from the absorber at the absorber temperature, which may be close to ambient temperature, is preheated in condensers 920 and 90 before it receives further heat in the main heat exchanger 100 from the lean line. In this example, the main heat exchanger may be smaller or remove less heat from the lean line 910, which means the lean line has greater heat available for recovery by heat exchanger 1110 and heat pump system 210.

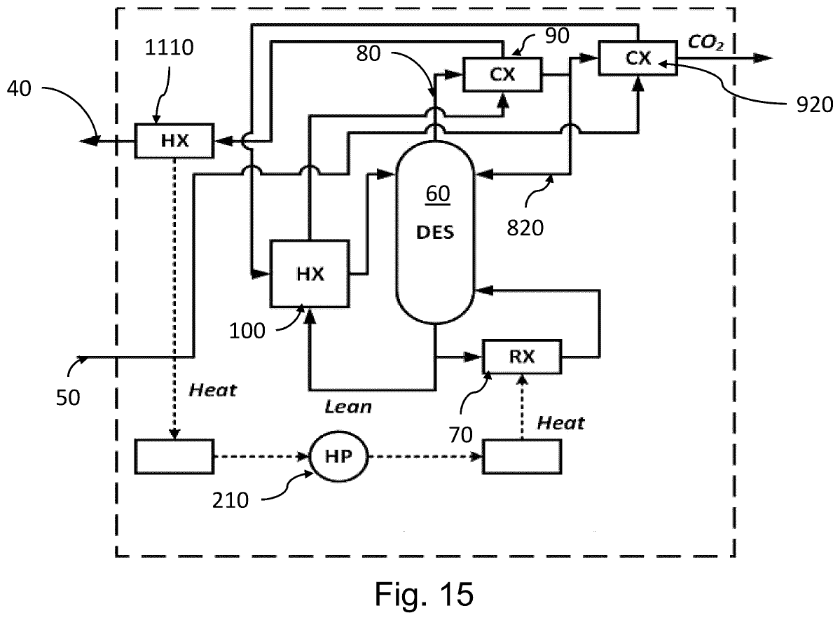

FIG. 15 is a variation of the systems of FIGS. 13 and 14, in this case the cool rich line 50 returning from the absorber is used to cool the second condenser 920 before being further heated by the main heat exchanger 100. The lean line is cooled by main heat exchanger 100, but then reheated by first condenser 90. Because the rich line 50 may be quite cool especially when the absorber is operated in a cold climate, additional heat may be recovered by the second condenser 920, while still providing the benefits of FIGS. 13 and 14 in terms of heat recovery from the first condenser 90 and a single heat pump to recover heat from the condenser and the lean return.

One aspect of the present disclosure is the recovery of heat from the absorber itself, as described with reference to FIGS. 2 to 7. As described above, recovery of heat from the absorber can also be used to control the absorber temperature, by cooling either the air or the liquid within the absorber. This has the advantage of maintaining the rate of CO2 capture by the sorbent, which in most cases is reduced in hotter environmental conditions. It can also moderate the water loss from the absorber by evaporation, or even recover water from the ambient air in some conditions.

Another aspect of the present disclosure is using the lean line return to transfer heat to a heat pump, after heat has been recovered from the condenser. This allows the simplification of the heat pump system by combining multiple heat sources into a single heat source at a constant temperature. Examples of this are shown in FIGS. 9 to 15.

Another aspect of the present disclosure is the control of the condenser temperature within a range. There is a trade off between maximising the enthalpy recovered in the exhaust stream from the desorber, which is mainly gaseous H2O and carbon dioxide, the efficiency of a heat pump system where the coefficient of performance varies with temperature difference, and the heat demand placed on the desorber by re-injecting hot condensate. It is desirable to remove as much H2O from the exhaust stream before further processing or transportation, as liquid water and CO2 combine to form an acid solution which can be damaging to plant and pipework. There is also a need to recover water to maintain the liquid balance in the desorber (to maintain the desorber pressure) and the carbon capture system as a whole.

Control of the condenser 90 temperature may be achieved using various systems as described herein. In FIGS. 8, 9 and 10, the condenser 90 temperature is set by the heat pump 210b, which may be selected to provide the desired condenser temperatures at the desired operating conditions. Or the heat pump may include controls to vary the flow rate of refrigerant through the condenser by control of the heat pump compressor, or by diverting a portion of the refrigerant to another heat source. Other methods of temperature control are known to the person skilled in the art of heat pumps and refrigeration.

In FIGS. 11 to 15, control of the condenser temperature is implemented by the flow of sorbent through the condenser. The condenser may be sized to achieve the desired temperature under the expected operating conditions, or a control system may vary the flow to maintain the desired temperature. For example, a bypass valve may operate to divert the flow of sorbent around the condenser.

In any of FIGS. 8 to 15, the control system may include one or more sensors that measure a value indicative of the condenser temperature or the condensate temperature, and control the temperature of the condenser based on the sensor readings as described above.

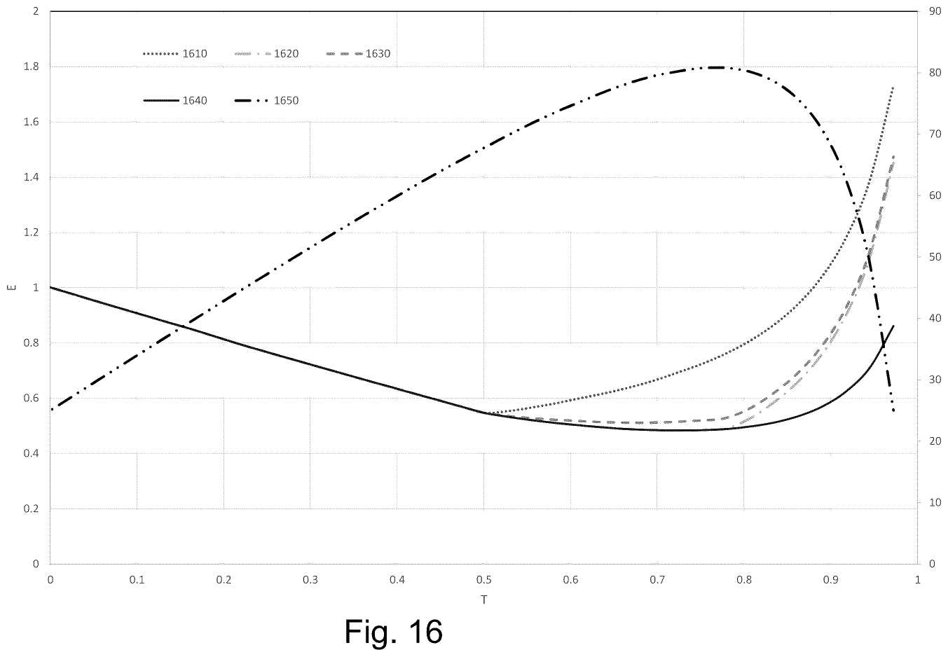

As the condenser outlet temperature increases, the available enthalpy for heat recovery decreases as more heat is lost in the exhaust stream leaving the condenser. At the same time, the coefficient of performance of a heat pump drawing heat from the condenser and supplying heat to the heating means increases. In addition to this, when the condensate is injected into the desorber to maintain the liquid balance, the condensate requires sensible heating to raise it to the temperature of the desorber. The resulting total heat demand has been calculated for some example systems and is show in FIG. 16. In principle, this model applies with minor variations within the scope of the skilled person to any desorber in a carbon capture system when a heat pump is used to recover heat from the absorber. The absolute temperatures will depend at least upon the choice of sorbent, the ambient operating conditions of the absorber, and the pressure in the desorber etc, and so the horizontal axis chart in FIG. 16 has been scaled from 0-1, 0 representing the ambient conditions and 1 the maximum temperature of the desorber exhaust stream when no heat is recovered. While there will always be a balance between sensible and latent heat to be determined, this will depend on the choice of operating pressure for the desorber system and will normally result in a dew point in the exhaust stream that is at a relatively fixed percentage of the maximum temperature.

The power requirement of the desorber, normally expressed in kW electrical, is the energy input to the heat pumps to generate the necessary heat taking into account the COP, plus any additional heat input needed which is assumed to be direct electrical heating if the demand is not met by the heat pumps. The desorber requires energy at a rate high enough to break the bonds between the sorbent and CO2, raise the temperature of the sorbent from the temperature in the absorber to a temperature where the equilibrium carbonation of the sorbent molecules is lower than the state in the absorber, and also to produce gas bubbles such as steam in the sorbent solution for the CO2 to diffuse into to facilitate the exit of CO2 from solution. This rate will depend on multiple conditions including the flow of sorbent through the desorber, which may be a fixed flow. The electricity supply may be grid electricity, or it may be supplied by local low carbon energy sources, such as wind power, solar power or nuclear power. On the vertical axis of the chart, this is expressed as a fraction of the heat required if the condenser was cooled to ambient temperature and all the available enthalpy recovered.

When heat is recovered from a second source with a second heat pump, the electrical input to the second heat pump is included in the desorber energy use. The carbon capture system may have other energy demands, such as fan power and pump power which may be assumed to be constant for the purpose of illustrating the effects of the present disclosure, so these are not included in the example calculations.

By modelling the enthalpy flow in the exhaust stream, mass flow and temperature of condensate, coefficient of performance of the heat pump system (including one or more heat pumps), a curve of net energy input required for heating the sorbent in the desorber can be obtained. A simulation system can be configured to calculate the energy use of each part of the heat pump system, and generate a desired temperature range for control of temperatures in order to minimise the energy use. In particular the temperature of the condenser may be controlled to minimise the energy use of the desorber in the system.

In FIG. 16, four example traces are plotted showing the total energy use of the absorber system.

Trace 1610 (dotted line) shows the energy (E) requirements of the absorber when the heat is supplied by a single heat pump recovering heat from a single condenser at temperature (T). As explained above, the horizontal axis T is scaled from absorber temperature at 0 to the maximum condenser temperature 1, as a relative temperature range. In an example, the ambient temperature is 25° C. and the maximum condenser temperature is 115° C. Trace 1610 shows a minima at T=0.5, with an energy use of 0.54. At low values of T, the maximum latent and sensible heat is recovered from the exhaust stream, but the condenser heat pump 210b has a low COP so more work provided by the heat pump is supplied as heat. Once the temperature reaches 50% of the range shown, there is less heat to recover and the HP is also adding less heat as work. Above this temperature, additional heat input is required by the absorber, and in this trace for illustration purposes it is assumed to be direct electrical heating. Therefore the total energy use increases with temperatures above 0.5, until at a point above T=0.8, the net energy use exceeds what would have been required at T=0. In an example, T=0.5 corresponds with 70° C. and the energy requirement, in an MEA based carbon capture system, equates to 1.67 GJ electricity per tonne CO2 released.

Trace 1620 (dashed and dotted line) shows the energy (E) requirements of the absorber when the heat is supplied by two independent heat pumps, one recovering heat from the condenser at temperature (T) and the lean return which has been re heated by a second condenser as shown in FIG. 9 for example, except that the heat pumps are connected in parallel rather than as a cascade. That is to say, the hot output of heat pump 210d is at the temperature of the heating means 70, and not at the temperature of the intermediate circuit 810. As explained above, the horizontal axis T is scaled from absorber temperature at 0 to the maximum condenser temperature 1. In an example, the ambient temperature is 25° C. and the maximum condenser temperature is 115° C. Trace 1620 shows a minima at T=0.72, with an energy use of 0.48 relative to a fully cooled condenser. Compared with trace 1610, the additional heat in the lean line, that includes residual heat from main heat exchanger 100 plus the additional heat gained from the second condenser 920 is recovered, at a lower COP than the COP of the condenser heat pump, but using much less input power than direct electric heating. Between T=0.5 and 0.8, when the backup heater is a second heat pump, it supplies the additional heat required without increasing the power input. The power use is reduced between T=0.5 and 0.72, and then rises slowly, only exceeding the power use of the single heat pump example of trace 1610 when T>0.83 (of the range between the absorber temperature and the desorber temperature). so the system can operate efficiently with the condenser controlled or configured to operate in a relative temperature range between T=0.5 and 0.83, preferably between T=0.6 and T=0.8, most preferably between T=0.7 and T=0.75. These ranges, in an example using MEA sorbent, or other sorbents that can be used to absorb at 0 to 30° C. and desorb above 90° C., have actual temperatures of 70 to 99° C., 79 to 97° C., 88 to 92° C.

Trace 1630 (dashed line) shows the energy (E) requirements of the absorber when the heat is supplied by two heat pumps in a cascade arrangement such as the arrangement in FIG. 9. One heat pump 210b recovering heat from the condenser at temperature (T) and the other 210d from the lean return which has been re heated by a second condenser 920 as shown in FIG. 9. In this case the heat pump that recovers heat from the lean return supplies heat into an intermediate circuit 810 so that it is combined with the heat from the condenser, and then moved to a higher temperature by the condenser heat pump. Trace 1630 does show slightly higher energy use than trace 1620 in the same operating temperature ranges for the condenser. However this difference is small and may be improved upon by optimising the choice of heat pumps. An advantage of the cascade arrangement over the independent heat pumps is that the lean line heat pump only needs to operate up to the temperature set point of the condenser, for example 70 to 99° C., 79 to 97° C., most preferably 88 to 92° C. . . . This means this second heat pump can be simpler and use more widely available refrigerants than a heat pump that needs to deliver heat at around 120° C. directly to the heating means.

The performance of heat pump 210d may be improved upon by running the lean line heat pump from a countercurrent heat exchanger to increase the source temperature for the heat pump, thus improving the COP.

Trace 1640 shows the energy performance of a system where the rich line is used to cool the second condenser 920, so that the cool rich sorbent stream returning from the absorber is preheated before entering main heat exchanger 100, resulting in a hotter lean line return as less heat transfer happens in the main heat exchanger. This arrangement is shown in FIG. 10 and described above. Trace 1640 shows a similar energy performance to trace 1620 up to a relative temperature of T around 0.8, but the performance range is extended at higher condenser temperatures. The energy use remains less than the energy requirements of the single heat pump system of trace 1610 and has a minimum between T=0.5 and T=0.86. The minimum is at T=0.72, which in an MEA sorbent example equates to 90° C., where the energy requirement is 0.48 of the energy requirement of a fully cooled condenser with a single heat pump. Between T=0.64 to T=0.80, the energy use is less than half of the cold single heat pump example. In absolute terms, the best performance is achieved at around 85° C. to 95° C., where in the MEA sorbent example the energy use is less than 1.49 GJ per tonne CO2 released.

Trace 1650 (dash-dot-dot) shows the mixed condensate temperature in degrees Celcius which is plotted against the right hand axis. When there are two condensers, in any example described herein, the condensate 820 maybe recovered after the first or second condenser 920 or both. Optional external heat sources may be used. The temperature of the first condenser can be set higher, to allow for heat pump 210b to operate at a high and consistent COP so that it will be mainly recovering latent heat with little temperature reduction across the condenser 90. The second condenser 920 can be sized so as to maximise both the heat content of the recovered condensate and the combined coefficient of performance of first and second heat pumps so as to minimise the input energy requirements of the heat pump system.

If the first condenser is operated so that about 88% to 71% of the available water vapor is recovered, then the second condenser can be operated at a much colder temperature to recover the remaining water, for example using the rich return line at ambient temperature or below for cooling the second condenser. Because the mass flow from the second condenser is only between 12% and 29% of the available moisture, the mixed temperature of the combined flows remains high. In an example, the condensate temperature of the mixed flow can be above 78° C. when the condenser outlet temperature of the first condenser is between 85 and 100° C. and the second condenser is cooled to 25° C. or below. This minimises the heat requirement for reheating the returned condensate in the desorber. This range of temperatures also overlaps with the range of temperatures in which a two heat pump system can minimise the energy requirements of the system.

In all the traces on FIG. 16, the performance data is derived from an MEA sorbent based system where the desorber reboiler operates at around 120° C., and the absorber is operating at ambient conditions of 25° C. However, the scales have been normalised to 0-1 between these two figures, as it is expected that heat pump performance and condenser performance will behave in a similar way in other systems with different end points of the operating range. The preferred relative condenser temperature ranges can therefore be applied to other systems using different sorbents than the one illustrated.

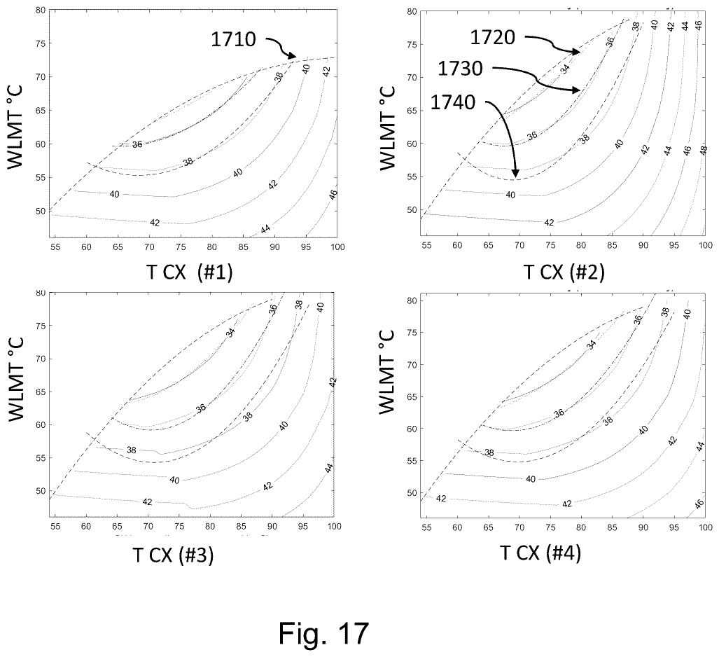

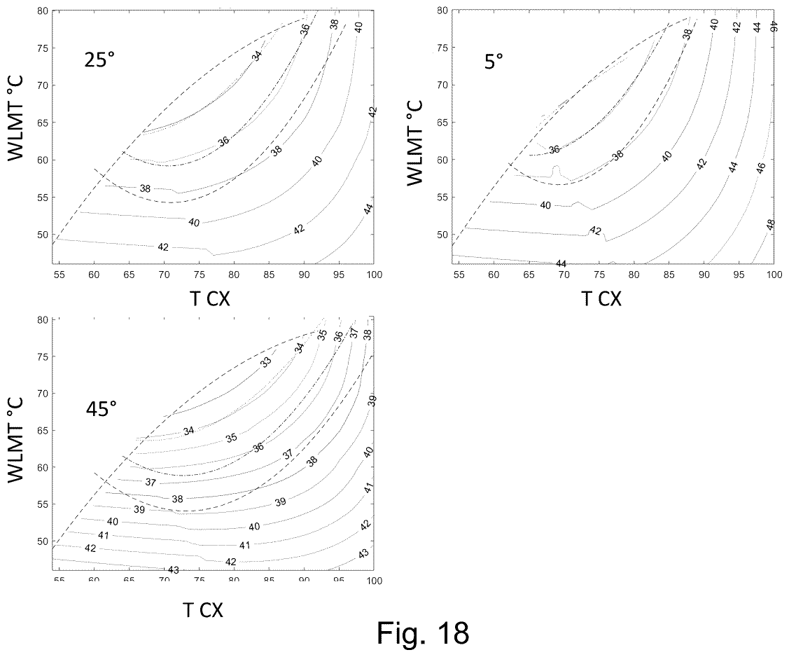

FIGS. 17 and 18 illustrate the advantages of the condenser and heat pump combinations described above and in particular the surprising improvement in energy efficiency that can be achieved by deliberate control of temperatures at two points in the system. For each variant of the systems above that use one or two condensers, the system can be generalised as an intermediate circuit such as a water loop that directly cools the first condenser, a low temperature heat pump that extracts heat from elsewhere, for example a second condenser either directly or indirectly using one of the other fluid circuits, and a heat pump that extracts heat from the water loop and supplies it to the heating means of the desorber. While some heat can always be recovered from both locations, optimising the heat recovery and maximising the coefficient of performance of the heat pumps requires specific control points to be implemented in the system. The optimum temperatures for the first condenser and the water loop also vary with ambient temperature. In this configuration, an optimum operating temperature range has been identified which can be used with in conjunction with some of the embodiments above, particularly those shown in.

In FIG. 17, contour plots of the energy use of 4 different system architectures are shown. Numbered lines 34 to 48 are contours of energy performance of the desorber shown as a percentage relative to a desorber with no heat pumps. So contour line “40” shows the operating regime where the desorber system would use 40% of the energy required compared to a directly heated desorber. That is, as above in respect of FIG. 16, the energy input to the heat pumps to generate the necessary heat taking into account the COP, plus any additional heat input needed which is assumed to be direct electrical heating if the demand is not met by the heat pumps, expressed as a percent of the heat requirement without the heat pump.

The horizontal axis T CX is the outlet temperature of the first condenser in degrees Celcius. A high temperature heat pump is extracting heat from the first condenser which is receiving exhaust from the outlet of the desorber and reducing the temperature of the exhaust stream to recover water and sorbent from the captured CO2. A water loop, or other heat transfer medium, connects the high temperature heat pump to the first condenser. In all the two heat pump system examples shown in FIGS. 17 and 18, there is a second heat pump removing heat from a second condenser heat exchanger, either directly or indirectly via one of the other fluid systems, and delivering heat to the water loop. The second heat pump therefore can be described as operating between the temperature of the second condenser and the minimum temperature of the water loop. The skilled person will understand that the actual flow and return temperatures of the heat pump on either side will actually be separated in temperature depending on the configuration of heat exchangers and flow rates. The minimum temperature of the water loop is plotted on the vertical axis, WLMT in degrees Celsius.

As well as the contour lines, there is shown a dashed boundary line 1710 which represents the limit beyond which no additional heat may be recovered, because the approach temperatures of the heat exchangers becomes too small, i.e. the fluid temperature in the heat transfer loop is too close to the temperature in the condenser or the second heat exchanger temperature.

Also shown are two or three dashed best fit lines, based on a quadratic equation derived for the respective minimum water loop temperature for the desired condenser temperature T CX. The lines do not need to be read from the charts, as the equations are provided below in tables 1 and 2. As an example on FIG. 17 chart for #2, 1720 is a best fit line to achieve approximately 34% of default energy use, 1730 for 36% and 1740 for 38%. The plant will use the lowest energy when operated in conditions between the 34% line and the boundary line 1710, but practical considerations, variations in ambient conditions and limitations of availability of correctly sized heat pumps and heat exchangers may require some flexibility. Therefore the plant can be designed to operate in the control region indicated by the 38% line, preferably the 36% line, even better above the 34% line. A controller may be configured to control the temperature of WLMT to keep the plant operating at better than 38% of default energy use based on the condenser temperature T CX. The controller may control the condenser temperature T CX to minimise the heat requirement for reheating the returned condensate in the desorber as described above in reference to FIG. 16. The energy performance shown in the contour plots in FIGS. 17 and 18 includes both of these optimisations.

It should be noted that TCX is cooler than the condensate temperature described for FIG. 16 as it is the exit temperature of the condenser heat exchanger and not the condensate itself.

The four DAC system architectures for which performance is illustrated in FIG. 17 are as follows:

Architecture (#1): a first condenser is cooled by a first coolant loop, second condenser CX2 is cooled by a Low Temperature Heat Pump directly or via a second coolant loop. High temperature heat pump transfers heat from the first coolant loop to the heating means of the desorber.

Architecture (#2): lean return is cooled bya Low Temperature Heat Pump 210d which heats a coolant loop 810 that also cools a condenser 90 as shown in FIG. 8.

Architecture (#3): second condenser CX2 pre-heats the cold rich line 50; the lean line return 40 feeds the Low Temperature Heat Pump 210d as shown in FIG. 10 except that the low temperature heat pump 210d delivers heat to a water loop 810 connected to the first condenser, instead of directly to the desorber heating means 70.

Architecture (#4): second condenser CX2 heats the lean line; the lean line return feeds the Low Temperature Heat Pump as shown in FIG. 9, where 810 is provided by a water loop.

Each of these system architectures #1 to #4 has one or two condensers and two heat pumps in a heat pump system as described in some embodiments above. As an option, a third condenser can be added with a third heat pump to obtain a further improvement to efficiency. There is a balance to be achieved between the coefficients of performance of each heat pump, the temperature of the condensate returned to the desorber, and delivering dry CO2. There are variations in the temperature of the sorbent in various sampling positions caused by variations in ambient temperature. For example, the rich return from the absorber will be close to the ambient wet-bulb temperature, except in systems where the absorber temperature is controlled. This has a knock on effect on the temperature of the lean flow to the absorber as it passes through the main heat exchanger. The rate of heat transfer in each condenser can be controlled as mentioned above by varying the fluid flow in the heat exchangers, or bypassing the condensers. Therefore the temperature of the outlet of the first condenser can be controlled, as can the lowest temperature in the water loop connecting the outlet of the second heat pump to the inlet of the high temperature heat pump that supplies heat to the desorber. The lowest temperature in the water loop is at the outlet from the heat exchanger supplying heat to the high temperature heat pump (for example 210b in FIGS. 8, 9 and 10).

A controller may be provided configured to control the first condenser outlet temperature and the water loop minimum temperature to provide the maximum effective coefficient of performance (COP) of the whole heat pump system as ambient conditions vary. Alternatively, the condensers and heat exchangers may be sized to provide the best average effective COP in typical ambient conditions for the location of the plant.

The best performing of these systems is architecture (#3) as described in FIG. 10: second condenser CX2 pre-heats the cold rich line 50; the lean line return 40 feeds the Low Temperature Heat Pump 210d as shown in FIG. 10 except that the low temperature heat pump 210d delivers heat to a water loop 810 connected to the first condenser, instead of directly to the desorber heating means 70.

FIG. 18 shows the performance of system #3 in 3 different ambient conditions, with ambient air temperature of 5, 25 and 40° Celcius. As can be seen, the desorber energy use can be lower when the ambient temperature is higher, due to the additional heat available to be recovered from the rich line.

The best performance available at ambient T=25° C. gives a minimum electrical duty=32.7% of the requirement with no heat pumps for #3 when T CX=72 degC and WLMT=69 degC. So a good operating regime would be T CX between 68 and 72° C. and WLMT between 65 and 69° C. This enables a direct air capture plant to operate using less than a third of the energy required for direct heating of the desorber. This may enable direct air capture to be operated using electricity more cheaply than a plant using fossil fuel to heat the desorber. Using low carbon electricity, such as renewables or nuclear power makes direct air capture a sensible option to reduce global warming.

T CX between 68 and 76° C. and WLMT between 65 and 69° C. would also provides a good performance for the other architectures. To avoid crossing the boundary line, a safer WLMT range between 61 and 67° with TCX between 68 and 72° C. is optimal in most operating conditions.

However as mentioned above, design constraints may mean the optimum conditions are not achievable. A compromise operating condition can be obtained for any of the described architectures by choosing a range of operating points on or above the 38% performance line (or the best fit to the 38% line), and designing or controlling the system to operate in a control region bounded by the 38% line, or 38% best fit line to form a quadrant like shape with its apex at T CX=72° C. and WLMT=69° C.

TABLE 1
Best Fit Water loop temperature required to achieve energy use
less than 38% of base case for different ambient conditions.

| | Ambient | |
|---|---|---|
| Architecture | Temp | Minimum water loop temperature |
| #1 | 5 | WLMT >= 0.0283 * TCX\hat{ }2 − |
| | | 3.91 * TCX + 192 |
| #1 | 25 | WLMT >= 0.0280 * TCX\hat{ }2 − |
| | | 3.83 * TCX + 186 |
| #1 | 45 | WLMT >= 0.0301 * TCX\hat{ }2 − |
| | | 4.17 * TCX + 198 |
| #2 | 5 | WLMT >= 0.0757 * TCX\hat{ }2 − |
| | | 10.32 * TCX + 409 |
| #2 | 25 | WLMT >= 0.0532 * TCX\hat{ }2 − |
| | | 7.32 * TCX + 306 |
| #2 | 45 | WLMT >= 0.0412 * TCX\hat{ }2 − |
| | | 5.85 * TCX + 260 |
| #3 | 5 | WLMT >= 0.0565 * TCX\hat{ }2 − |
| | | 7.82 * TCX + 327 |
| #3 | 25 | WLMT >= 0.0381 * TCX\hat{ }2 − |
| | | 5.41 * TCX + 246 |
| #3 | 45 | WLMT >= 0.0327 * TCX\hat{ }2 − |
| | | 4.85 * TCX + 234 |
| #4 | 5 | WLMT >= 0.0547 * TCX\hat{ }2 − |
| | | 7.52 * TCX + 316 |
| #4 | 25 | WLMT >= 0.0366 * TCX\hat{ }2 − |
| | | 5.10 * TCX + 233 |
| #4 | 45 | WLMT >= 0.0323 * TCX\hat{ }2 − |
| | | 4.72 * TCX + 227 |

The refrigerants used in the heat pumps may be the same or different. There are only a few refrigerants that can operate in the saturation regime up to 130° C. or more (ignoring more complex cycles using supercritical properties, such as transcritical cycles, for simplicity). These include for example R717 (ammonia), R718 (steam/water, although this is not suited to low temperature operation), R600 (butane, flammable), and R1233zd (1-chloro-3,3,3-trifluoroprop-1-ene, developed as a lower Global Warming Potential refrigerant for future air conditioning products). As a note, high temperature refrigerants below 120° C. include R245fa (1,1,1,3,3-pentafluoropropane, GWP 858), R717 (ammonia, GWP 0), R744 (carbon dioxide, GWP 1), R134a (1,1,1,2-tetrafluoroethane, GWP 1300), R1234ze (E) (1,3,3,3-tetrafluoropropene, GWP 6); and those being developed for applications above 120° C. include R1336mzz (Z) (cis-1,1,1,4,4,4-hexafluoro-2-butene, GWP 2), R718 (water/steam), R245fa, R1234ze (E), R600 (butane, GWP 4-6.5) and R601 (pentane, GWP 4±2).

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A system for the capture of carbon dioxide (CO2) from a CO2 containing gas stream, the system comprising:
an absorber to contact the CO2 containing gas stream with a sorbent, the sorbent operable to capture CO2 from the CO2 containing gas stream in a first temperature range and release CO2 at a second temperature range;
the absorber comprising means to move the CO2 containing gas stream through the absorber from an absorber inlet to an absorber outlet;
a desorber to release the CO2 from the sorbent, the desorber operable to receive a rich sorbent stream from the absorber, heat the sorbent using heating means to provide heat to increase the sorbent temperature from the first temperature range to the second temperature range, an exhaust conduit to supply an exhaust stream comprising CO2 and vapor to a CO2 outlet;
a lean return stream to return the sorbent from the desorber to the absorber;
a main heat exchanger between the desorber and the absorber to remove heat from the lean return stream and add heat to the rich sorbent stream;
and at least one additional heat exchanger to add heat to either the lean return stream after the main heat exchanger or to the rich stream before the main heat exchanger so as to produce a hot lean return stream; and
a heat pump system configured to remove heat from the hot lean return stream and supply heat to the heating means.

2. The system of claim 1, wherein the at least one additional heat exchanger is a condenser configured to cool the exhaust stream and produce condensate.

3. The system of claim 2, wherein the condenser is configured to have an outlet temperature within a third temperature range, and the condenser is fluidly connected to a condensate recovery circuit to deliver the condensate into the desorber.

4. The system of claim 2, the condenser comprising a first and second condenser on the exhaust stream, each configured to cool the exhaust stream and produce condensate, wherein the first condenser receives the exhaust stream before the second condenser during operation.

5. The system of claim 4, wherein heat pump system is further configured to cool the first condenser and the second condenser is cooled by the lean return stream or the rich sorbent stream.

6. The system of claim 5, wherein the heat pump system comprises:
a coolant loop arranged to cool the first condenser;
a low temperature heat pump configured to transfer heat from the lean return stream to the coolant loop; and
high temperature heat pump configured to transfer heat from the coolant loop to the heating means, wherein the minimum temperature in the coolant loop and the temperature of the coolant loop leaving the first condenser are controlled to maximise the coefficient of performance of the heat pump system.

7. The system of claim 4, wherein the second condenser is cooled by the lean return stream and the first condenser is cooled by the lean return stream after it has been heated by the second condenser.

8. The system of claim 4, wherein the second condenser is cooled by the rich sorbent stream and the first condenser is cooled by the rich sorbent stream after it has been heated by the second condenser.

9. The system of claim 4, wherein the second condenser is cooled by the rich sorbent stream and the first condenser is cooled by the lean return stream after it has been cooled by the main heat exchanger.

10. The system of claim 1, wherein the CO2 containing gas stream is ambient air.

11. A method of capture of carbon dioxide (CO2) from a CO2 containing gas stream, the method comprising:
providing a condenser system in an exhaust stream from a desorber in a carbon capture system, the condenser operable to recover condensate and deliver it to the desorber;
passing either lean or rich sorbent streams of the carbon capture system through the condenser to cool the condenser;
recovering heat from the lean return stream using a heat pump to supply heat to heating means in a desorber of the carbon capture system.

12. The method of claim 11, where the lean sorbent stream is passed through the condenser to heat the lean sorbent stream, after the lean sorbent stream has been cooled in a main heat exchanger by heating the rich sorbent stream.

13. The method of claim 11, where the rich sorbent stream is passed through the condenser to heat the lean sorbent stream, before the lean sorbent stream is cooled in a main heat exchanger by heating the rich sorbent stream.
